(19) United States
(12) Patent Application Publication
(10) Pub. No.: US 2010/0211513 A1
(43) Pub. Date: Aug. 19, 2010

(54) IMAGE FORMING SYSTEM AND IMAGE FORMING APPARATUS

(75) Inventor: Hajime Yoshida, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/707,087

(22) Filed: Feb. 17, 2010

(30) Foreign Application Priority Data
Feb. 19, 2009 (JP) 2009-036354

(51) Int. Cl. G06Q 50/00; G06F 15/00; G06Q 10/00

(52) U.S. Cl. 705/317; 358/1.15

(57) ABSTRACT

An image forming system that realizes a point system more appropriately corresponding to a degree of effects on environment is provided. The image forming system includes an image forming apparatus for giving a deduction point depending on use of resources and an addition point that is given to an energy-saving operation for the apparatus by the user, and a point management server for performing authentication processing of a user and also accumulating deduction points and addition points calculated by the image forming apparatus and managing for each user, in which an addition point calculated depending on the lapse of time passed since a user used the image forming apparatus last time and a point giving rate per unit time assigned to the user is added to the point, the point is managed for each user, and the point of a predetermined period is reported to each user.

### CROSS-NOTING PARAGRAPH

This non-provisional application claims priority under 35 U.S.C. §119(a) on Patent Application No. 2009-036354 filed in JAPAN on Feb. 19, 2009, the entire contents of which are hereby incorporated herein by reference.

### FIELD OF THE INVENTION

The present invention relates to an image forming system and an image forming apparatus shared and used by a large number of people and use thereof for each user is managed and controlled.

### BACKGROUND OF THE INVENTION

In recent years, it is requested to take urgent measures to develop eco-products considered environmental problems.

Since image forming apparatuses such as digital multi-function peripherals include a copy function and a print function, they consume comparatively large amount of resources by heating, applying a toner to paper, and the like, and an efficient use of resources are strongly required in view of decreasing effects on an environment.

Conventional image forming apparatuses are including such a function that reports the number of used paper sheets, the amount of consumed toner, power consumption, and the like, however, because the function is not requested from the view point of decreasing an effect on environment, it is not possible to easily grasp a degree of effects on an environment.

In an image forming apparatus of Japanese Laid-Open Patent Publication No. 2007-329610, it is intended to promote energy-saving use depending on a use environment of a user and to decrease effects on an environment and to save a user cost by adding a count value set in advance to an energy-saving counter for each printing, according to a print mode (aggregate print, printing on the back side of used paper, scaling printing, double-sided printing, toner saving, power-saving printing, etc.) in printing, when an energy-saving operation mode is selected for contributing to saving of a consumed amount of paper, a toner, or power to be used.

However, an invention described in Japanese Laid-Open Patent Publication No. 2007-329610 is the one for promoting energy-saving use, and a count value of the energy-saving counter does not correspond to a degree of effects on an environment. Therefore, there arises a problem that a user who refrains from using an image forming apparatus by using an electronic document or the like is not appreciated.

### SUMMARY OF THE INVENTION

An object of the present invention is to provide an image forming system and an image forming apparatus that realize a point system more appropriately corresponding to a degree of effects on an environment.

An image forming system of an invention of the present application is an image forming system including an image forming apparatus for giving a deduction point depending on use of resources such as paper or toner when used by a user and an addition point that is given to an energy-saving operation for the apparatus by the user, and a point management server for performing authentication processing of a user requested from the image forming apparatus and also accumulating deduction points and addition points calculated by the image forming apparatus and managing for each user, in which an addition point calculated depending on the lapse of time passed since a user used the image forming apparatus last time and a point giving rate per unit time assigned to the user is added to the point, the point is managed for each user, and the point of a predetermined period is reported to each user.

The addition point above is calculated, when the point management server receives a request of authentication processing of a user from the image forming apparatus, depending on the lapse of time since the user used the image forming apparatus last time and a point giving rate per unit time assigned to the user.

Point deduction or point addition was performed in the following situations.

(1) A deduction point calculated depending on a used amount and a paper size of paper consumed for printing is deducted from the point.

(2) A deduction point calculated depending on a consumed amount of toner is deducted from the point.

(3) A predetermined deduction point is deducted from the point when a fixing roller of the image forming apparatus is heated to a temperature required for printing.

(4) The image forming apparatus has a function of performing user authentication in a sleep mode, and when the user authentication is accompanied by restoration from the sleep mode, a predetermined deduction point is deducted from the point.

(5) In a case where moving to a sleep mode is accompanied when use of the image forming apparatus is ended, a predetermined addition paint is added to the point.

In addition, the image forming apparatus, when the point of a user has become not more than a predetermined threshold, makes the user incapable of operating a function of performing point deduction.

Moreover, a value of the predetermined deduction point may be adjusted depending on an apparatus attribute of the image forming apparatus.

In addition, the image forming apparatus of the present invention is the image forming apparatus for performing authentication processing of a user and also accumulating a deduction point depending on a used amount when a user uses resources such as paper or toner and an addition point that is given when the user performs an energy-saving operation of the apparatus and managing the accumulated points for each user, and when receiving a request of authentication processing by a user operation, an addition point calculated depending on lapse of time passed since the user used the image forming apparatus last time and a point giving rate per unit time assigned to the user is added to the point, and the point is managed for each user, and the point of the predetermined period is reported to each user.

Point deduction or point addition of the eco-point is performed similarly in the above-described image forming system, and further, in the case of authentication accompanied by restoration from the sleep mode, when the point of the user is a predetermined threshold or less, operation of the apparatus maybe prohibited by rejecting authentication.

### BRIEF DESCRIPTION OF THE DRAWINGS

FIG. 1 is a block diagram for showing a configuration of an image forming system according to an embodiment of the present invention;

FIG. 2 is a diagram for showing a configuration of an operation panel apparatus;

FIG. 3 is a flowchart for showing registration processing of a user who uses an image forming system;

FIG. 4 is a flowchart for showing authentication processing in starting execution of a print job;

FIG. 5 is a flowchart for showing accumulation processing of eco-points when a print job is executed;

FIG. 6 is a flowchart for showing accumulation processing of eco-points when a print job is ended; and

FIG. 7 is a flowchart for showing authentication processing when the image forming apparatus is in a sleep mode.

### PREFERRED EMBODIMENTS OF THE INVENTION

Description will hereinafter be given for preferred embodiments according to an image forming system and an image forming apparatus of the present invention with reference to the drawings.

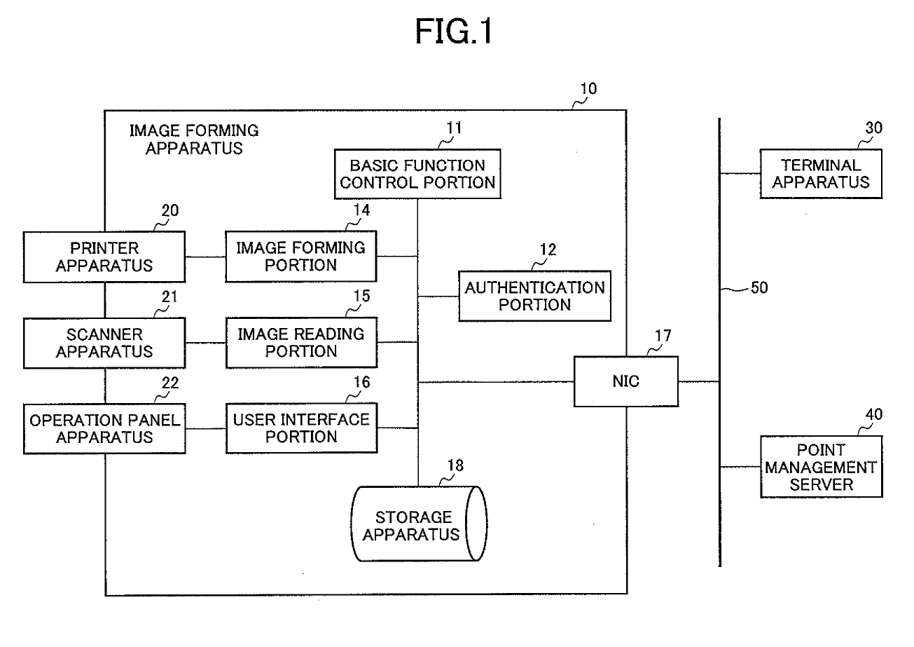

FIG. 1 is a block diagram for showing a configuration of an image forming system according to an embodiment of the present invention. In the figure, the image forming system is consisted of one or more image forming apparatuses 10, one or more terminal apparatuses 30, and one point management server 40 connected through a network 50 such as a LAN (Local Area Network).

In the figure, the image forming apparatus 10 includes a basic function control portion 11, an image forming portion 14, an image reading portion 15, a user interface portion 16, an authentication portion 12, a storage apparatus 18, a network interface card (NIC) 17, a printer apparatus 20, a scanner apparatus 21, and an operation panel apparatus 22.

The image forming apparatus 10 in the present embodiment is described here as a digital multi-function peripheral mounting a function of detecting a face side or a reverse side of printing paper, a function of measuring a consumed amount of a toner, a function of measuring a temperature of a fixing roller, a function of detecting a size of printing paper, a sleep mode, and the like, and having multiple functions of copying, printing, a facsimile, a scanner, network communication, and the like.

The basic function control portion 11 is a module that provides standard functions (copying, printing, a facsimile, a scanner, network communication, and the like) of conventional digital multi-function peripherals, and controls operation of the entire image forming apparatus 10 based on information related to each of the functions stored in the storage apparatus 18. For example, the basic function control portion 11 monitors an input instruction from an input portion of the operation panel apparatus 22, executes any one of various modes appropriately in response to an input from the NIC 17, and also controls the scanner apparatus 21, a printer apparatus 20, and the like.

The image forming portion 14 applies every kind of image processing to image data stored in the storage apparatus 18 appropriately, controls the printer apparatus that is connected, and prints on paper. In addition, the image forming portion 14 may control NIC to receive image data from an external terminal apparatus 30 and print an image on paper in some cases.

The image reading portion 15 controls the scanner apparatus 21 that is connected, reads an image of an original document, and stores image data showing the image in the storage apparatus 18. Thereafter, in accordance with processing contents instructed from the input portion of the operation panel apparatus 22, the image data stored in the storage apparatus 18 is read sequentially at the right time and transferred to the printer apparatus 20. In addition, the image reading portion 15 may control the NIC 17 to transmit the image data to the external terminal apparatus 30 in some cases.

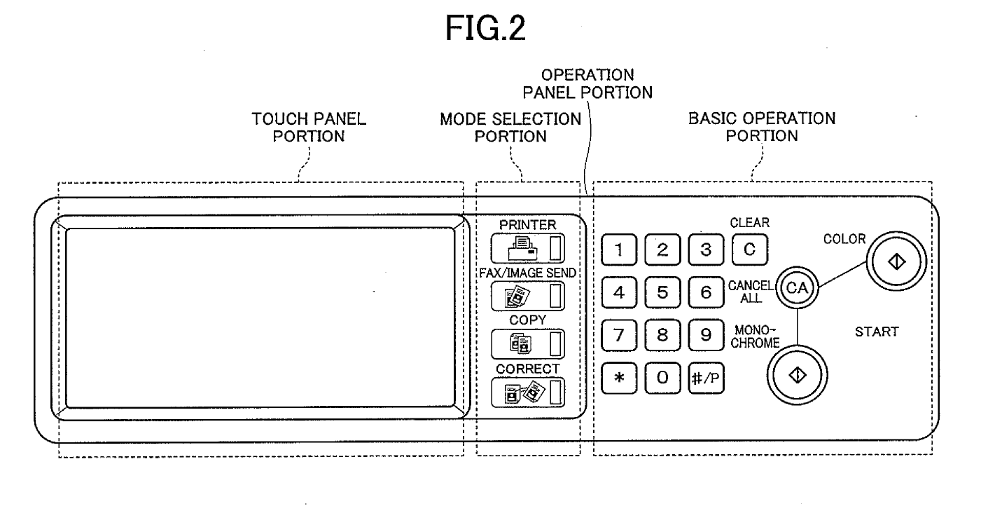

As shown in FIG. 2, the operation panel apparatus 22 includes a basic operation portion in which a numeric keypad, a clear key, a start key, and the like are disposed, a mode selection portion in which buttons for switching a function mode (a copy function, a scanner function, a printer function, etc.) are disposed, an input portion comprised of a touch panel portion on which a touch operation is possible for a detailed setting screen of each function, and a display portion comprised of a liquid crystal display provided integrally with the touch panel portion.

The user interface portion 16 receives an operation of a user by the input portion by controlling the operation panel apparatus 22 that is connected, and displays results of the input, processing, and the like on the display portion depending on an instruction of the basic function control portion 11. In the display portion, an eco-point according to the present invention described below is displayed.

The storage apparatus 18 is a high-capacity non-volatile storage apparatus such as a hard disc, and stores information related to each function portion controlled by the basic function control portion 11 and a progress in the middle of processing or a processing result of each function portion.

The authentication portion 12 performs identity verification of a user who is capable of using the image forming apparatus 10 and confirmation of a function accessible by the user. The authentication portion 12 is realized by constructing a database in which information related to users is registered in advance on the point management server 40 connected to the network 50 and calling a function of authentication software.

Next, the terminal apparatus 30 is comprised of a computer including an input apparatus comprised of a mouse or a keyboard, a display apparatus, or a storage apparatus, and transfers a print job to the image forming apparatus 10 by application software on the storage apparatus, performs display of an inquiry from the image forming apparatus 10 and a response, and also displays eco-points (described below) sent from the point management server 40 on the display apparatus.

In addition, the terminal apparatus 30, when used by an administrator of the image forming system, is also used to register information related to users who use the system in the point management server 40.

The point management server 40 is comprised of a computer including a user information storage portion that stores information related to users who are capable of using the image forming apparatus 10 managed by the server, and performs authentication of a user sent from the image forming apparatus 10, updates the user information storage portion with eco-points accumulated for each user, and reports the eco-points of the user by e-mail and the like to the administrator and the user of the image forming system at every predetermined period.

Next, description will be given for an outline of processing of the image forming system of the present embodiment. Description will be given here by using an example in which a user transmits a print job from the terminal apparatus and the image forming apparatus prints the received print job.

In the present invention, a degree showing the height of consciousness to environment is quantified, and it is assumed that the larger the value is, the more is considered to environment. The quantified degree is called an eco-point.

First, the information related to users who are capable of using the image forming system is registered in the user information storage portion. In the user information storage portion, authentication information of a user (a user ID, a password, usable functions, etc.), a mail address, an accumulated value of eco-points, a point giving rate, the last time when the user was authenticated, etc., are stored for each user.

Here, the point giving rate is the number of points per unit time that is given when the image forming apparatus was not used, and a different value is determined depending on a duty of a user.

In user registration, the administrator of the image forming system registers authentication information, a mail address, and a point giving rate of a user in the user information storage portion from the terminal apparatus 30, and an accumulated value of eco-points and the last time when the user was authenticated is initialized.

Next, when the user transmits a print job from the terminal apparatus 30 to the image forming apparatus 10, the image forming apparatus 10 gives an inquire to the point management server 40 whether the print job is from a user subjected to user registration and performs authentication.

The point management server 40 performs user authentication, and also calculates a point P by using (formula 1). The point giving rate is assumed to be determined to be a point P that is on the same level in duties for which the image forming apparatus is frequently used and not frequently used.

Point P={(The time when the authentication succeeded)−(The last time when the user was authenticated)}×(Point giving rate) (Formula 1)

A point P calculated by replacing the last time when the user was authenticated with the time when the authentication succeeded, is added to an accumulated value of eco-points of the user, and the user information storage portion is updated.

Thereafter, a signal of successful authentication and the accumulated value of eco-points are sent back to the image forming apparatus 10 that requested authentication. Alternatively, when the authentication is unsuccessful, a signal of unsuccessful authentication is sent back to the image forming apparatus that requested authentication.

Next, the image forming apparatus 10, after the authentication is successful, executes printing of the print job. When printing is executed, the following points are given.

(1) When heating a fixing roller, a predetermined deduction point P1 is given.

(2) A deduction point P2 set in advance for each size of paper is given.

(3) A point to be deducted is set in advance for toner consumption per predetermined unit, and the point is multiplied by a toner consumption amount to calculate a deduction point P3.

(4) When accompanied by restoration from a sleep mode, a predetermined deduction point P4 is given.

(5) When accompanied by moving to a sleep mode, a predetermined deduction point P5 is given.

The image forming apparatus 10, when the user ends the use of the image forming apparatus 10, adds a deduction point and an addition point to an accumulated value of the eco-points sent from the point management server 40 in authentication to transmit to the point management server 40.

The point management server 40 updates the user information storage portion with the accumulated value of the eco-points of a user sent from the image forming apparatus 10.

Then, at every predetermined period, an accumulated value of eco-points for each user is reported to the administrator and a user of the image forming system by e-mail.

Furthermore, in starting each function of consuming resources such as paper or toner, when an accumulated value of eco-points of a user is below a preset value (referred as an execution permission threshold) set in advance, cancellation of execution of a function may be reported to the user.

Since an eco-point is reported to each user in this manner, it is possible to promote raising users' consciousness of consideration to environment.

Next, the present embodiment will be described in detail.

First, in the user information storage portion of the point management server 40, the following information is registered for each user.

User ID: an identifier for each user that is generated by the image forming system.

Password: a password that is generated when a new user is registered and changeable by a user, and used together with a user ID when taking authentication.

User name: a name of a new user who is capable of using the image forming system.

E-mail address: used when an accumulated value of eco-points is reported to a user.

Usable function: a function of the image forming apparatus usable by a user.

Point giving rate: the number of points per unit time that is giver for each user depending on the duty.

Execution permission threshold: a threshold that is given for each user to determine whether or not authentication or function execution is possible.

Accumulated value of eco-points: an accumulated value of eco-points that is currently held by a user.

The last time when the authenticated: the last time when the user was authenticated in the image forming system.

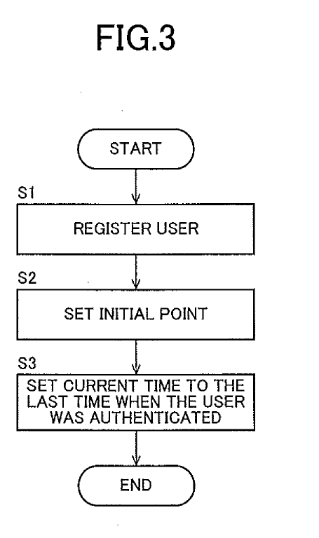

Next, description will be given for registration of a user who uses the image forming system based on a flowchart of the FIG. 3.

In the point management server 40, when the server is activated, a user management application is operated in a form of a Web application.

The administrator of the image forming system accesses the user management application of the point management server 40 by using a Web browser operating in the terminal apparatus 30 to execute an operation of adding a user. At this time, the administrator inputs a name of a new user, a mail address, a usable function, a point giving rate per unit time, an execution permission threshold, and the like on the browser to transmit to the point management server 40.

The point management server 40, when information related to a new user to be registered is sent, generates the user ID and the password for the new user, adds a new record to the user information storage portion, and sets the user ID, the password, the name of the new user, the mail address, the usable function, the point giving rate, and the execution permission value (step S1).

Next, an accumulated value of eco-points is set in the user information storage portion as zero (step S2), and the time when the user registration was performed is set in the user information storage portion as the last time when the user was authenticated (step S3), and the user registration is completed.

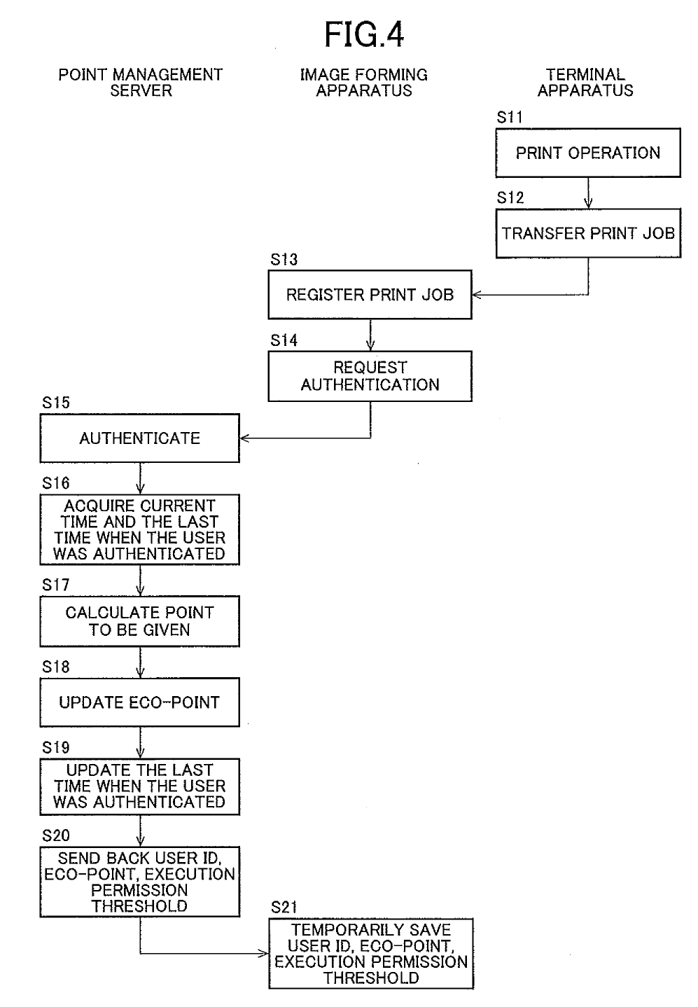

Next, description will be given for authentication processing in starting execution of a print job base on a flowchart of FIG. 4.

In the point management server 40, when the server is activated, the point management application is operated in the form of the Web application.

The terminal apparatus 30, when the user requests to print a document from a menu or the like of the application, (step S11), transmits a print job comprised of authentication information (a user ID and a password) registered in advance in the terminal apparatus 30 and print data to a specified image forming apparatus 10 (step S12).

The image forming apparatus 10, when receiving the print job, generates job ID to store in a storage apparatus that holds a print queue (step S13).

Next, in the image forming apparatus 10, a print job for which execution is started is taken out from the print queue, and authentication information that is added to the print job and a print request are transmitted to the point management server 40 to inquire whether authentication is possible (step S14).

In the point management server 40, it is checked whether or not authentication information (a user ID and a password) sent for an authentication request received from the image forming apparatus 10 is stored in the user information storage portion and a print request is included in functions usable by a user (step S15).

Here, when the sent authentication information is not stored in the user information storage portion or the print request is not included in the functions usable by a user, notification that the authentication was unsuccessful is given to the image forming apparatus 10.

In the image forming apparatus 10, a print job that received the notification of the unsuccessful authentication is discarded, and the notification of the unsuccessful authentication is sent back to the terminal apparatus 30 that transmitted the print job.

In the terminal apparatus 30, a message stating that printing was not able to be performed due to the unsuccessful authentication of the print request is displayed on the display apparatus.

On the other hand, when the authentication information that has been sent is stored in the user information storage portion, and a print request is included in functions usable by the user, the last time when the user was authenticated and the current time are acquired from the user information storage portion (step S16).

Next, a point giving rate of the user is acquired from the user information storage portion, a point to be given is calculated by the (formula 1) (step S17), which is added to an accumulated value of eco-points to update the user information storage portion (step S18).

Next, the last time when the user was authenticated in the user information storage portion is replaced with the current time acquired at step S16 to update the user information storage portion (step S19).

Finally, the point management server 40 acquires a user ID of a user whose authentication was successful, an accumulated value of eco-points, and an executable threshold from the user information storage portion, and returns a signal of successful authentication to which they are added to the image forming apparatus 10 that requested authentication (step S20).

In the image forming apparatus 10, upon receipt of the signal of successful authentication, the accumulated value of eco-points and the executable threshold added thereto are stored in a point integration table corresponding to the user ID.

As described above, when authentication processing of a user is completed successfully, a user ID, an accumulated value of eco-points, and an executable threshold are held in the point integration table for each user.

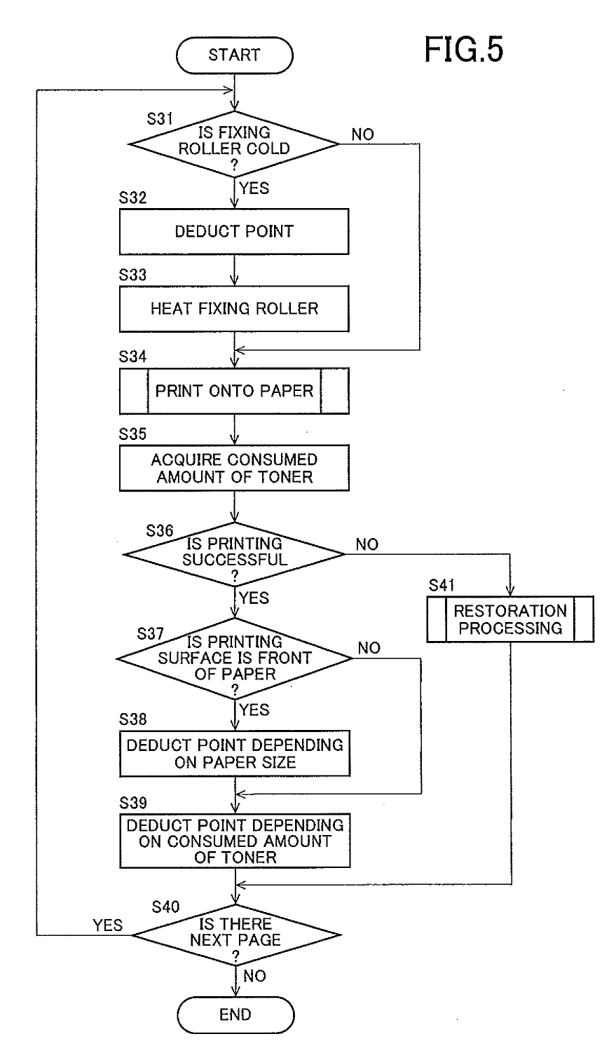

Next, based on a flowchart of FIG. 5, description will be given for accumulation processing of eco-points when a print job is executed.

In a case where a print job becomes an execution status, it is checked whether a fixing roller included in the printer apparatus 20 has reached a temperature required for printing, and in a case where the fixing roller has not reached the temperature required for printing (in the case of YES at step S31), a point P1 set in advance is deducted from the accumulated value of eco-points that is stored in the point integration table of the user to update the accumulated value (step S32), the fixing roller is heated and a printing is made ready (step S33).

In a case where the fixing roller has reached the temperature required for printing and preparations for printing are completed, print data of each page of a taken out print job is formed by the image forming portion 14, and is printed out on paper by the printer apparatus 20 (step S34).

In a case where the used amount of toner consumed in printing is acquired from the printer apparatus 20 (step S35) and an error such as a paper jam occurred in printing processing of a page (in the case of NO at step S36), the existing restoration processing is performed (step S41), and the procedure proceeds to step S40. A point when an error occurred is not treated as an object to subtract.

On the other hand, when printing processing of a page is completed without an error such as a paper jam (in the case of YES at step S36), whether a printing surface is a face side of paper is acquired from the printer apparatus 20, and in the case of unused paper (in the case of YES at step S37), a point P2 depending on a paper size acquired from the printer apparatus 20 is deducted from the accumulated value of eco-points that is stored in the point integration table of the user as new paper was used to update the accumulated value (step S38), and furthermore, a point P3 calculated depending on the used amount of toner is deducted to update the accumulated value of eco-points in the point integration table of the user (step S39).

When there is an instruction of a next page in the print job (in the case of YES at step S40), the procedure returns to step S31. Alternatively, when there is no instruction of a next page in the print job (in the case of NO at step S40), the print job is ended.

Alternatively, when the accumulated value of eco-points stored in the point integration table of the user is checked before printing is executed at step S34 above and the accumulated value is below the executable threshold, the print job may be ended without performing print execution.

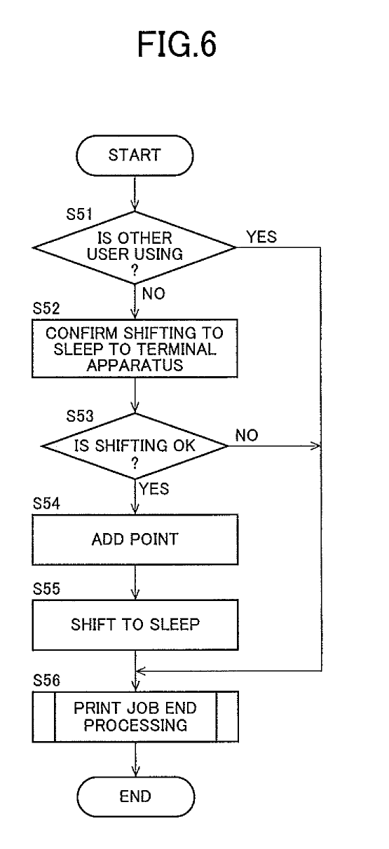

Next, description will be given for accumulation processing of eco-points when a print job is ended based on a flowchart of FIG. 6.

When the print job is ended in the image forming apparatus 10, whether other user is using the image forming apparatus 10 is determined and in the case of being used by other user (in the case of YES at step S51), the procedure proceeds to step S56.

On the other hand, in the case of not being used by other user (in the case of NO at step S51), “a dialogue to ask if it is possible to execute shifting to a sleep mode” is displayed on the display apparatus of the terminal apparatus 30 of the user which sent the ended print job (step S52).

When the image forming apparatus 10 receives an instruction “not to shift to a sleep mode” from the terminal apparatus 30 of the user (in the case of NO at step S53), the procedure proceeds to step S56.

On the other hand, when the image forming apparatus 10 receives an instruction “to shift to a sleep mode” from the terminal apparatus 30 of the user (in the case of YES at step S53), a point P5 set in advance when accompanied by shifting to a sleep mode is added to the accumulated value of eco-points that is stored in the point integration table of the user (step S54), and the image forming apparatus 10 is shifted to a sleep mode (step S55).

Finally, the image forming apparatus 10 transmits to the point management server 40 a print end signal to which a user ID of the ended print job and the accumulated value of eco-points stored in the point integration table of the user are added, and deletes the ended print job and the point integration table of the user (step S56).

At this time, the point management server 40 receives the print end signal sent from the image forming apparatus 10, and replaces an accumulated value of eco-points corresponding to the received user ID with the received accumulated value of eco-points to update the user information storage portion.

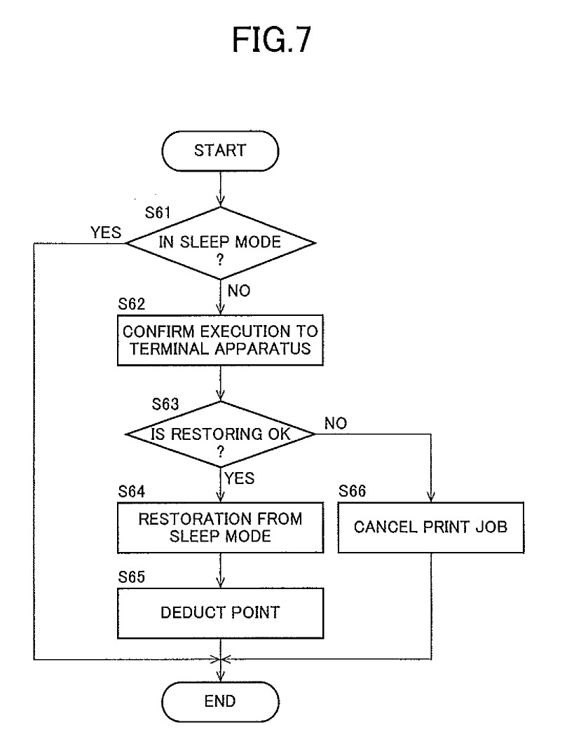

Next, description will be given for authentication processing when an image forming apparatus 10 is in a sleep mode based on a flowchart of FIG. 7.

When a user sent a print job by the terminal apparatus 30, an image forming apparatus 10 performs user authentication processing in FIG. 4 without turning on a main power supply by executing network communication, and subsequently, a restoration operation from a sleep mode in FIG. 7 is performed.

After authentication was successful in the user authentication processing, it is determined whether the image forming apparatus is in a sleep mode, and in the case of not being in a sleep mode (in the case of NO at step S61), the user authentication processing is assumed to be completed and print execution of the print job is performed.

However, when the image forming apparatus 10 is in a sleep mode (in the case of YES at step S61), “a dialogue to ask if it is possible to restore from a sleep mode” is displayed on the display apparatus of the terminal apparatus 30 of the user which sent the print job (step S62).

When the image forming apparatus 10 receives an instruction “it is possible to restore from a sleep mode” from the terminal apparatus 30 of the user (in the case of YES at step S63), the image forming apparatus 10 is caused to restore from a sleep mode (step S64), a point P4 when accompanied by restoration from a sleep mode is deducted from the accumulated value of eco-points stored in the point integration table of the user to update the point integration table of the user (step S65), and print execution of the print job is performed.

On the other hand, the image forming apparatus 10, when receiving an instruction “not to restore from a sleep mode” from the terminal apparatus 30 of the user (in the case of NO at step S63), deletes the print job and the point integration table of the user, and also transmits cancel of the print job to the terminal apparatus 30 having sent the print job (step S66), and stands by until the next print job is received.

The terminal apparatus 30, when receiving the cancel of the print job, displays a message stating that the print request has been cancelled.

Next, description will be given for a case where a user directly operates the image forming apparatus 10.

In the case of using the image forming apparatus 10, first, a user inputs authentication information (a user ID and a password) on an authentication start screen on the touch panel portion of the operation panel apparatus 22.

The user authentication information above may be input by using an authentication token such as an IC card, instead of being input from the operation panel apparatus 22.

The image forming apparatus 10 transmits the authentication information (a user ID, a password, etc.) of the user to the point management server 40 when the authentication information of the user is input. For authentication processing and a calculation of a point to be given in the point management server 40, the ones described above are used, and the user is able to operate various functions (copying, printing, scanning, etc.) when the authentication is successful.

However, when the authentication is not successful, the authentication start screen is displayed after a message stating that the authentication was unsuccessful was displayed on the display portion of the operation panel apparatus 22.

Next, when the user executes the various functions, a point that is produced due to the function executed is deducted from the accumulated value of eco-points stored in the point integration table of the user and an update is performed.

Alternatively, prior to execution of a function of consuming resources such as paper and toner, the accumulated value of eco-points stored in the point integration table of the user is checked, and when the accumulated value is below the executable threshold, execution of the function may not be performed.

Next, when the user performs an end operation on the touch panel portion of the operation panel 22 at the time of finishing the use of the image forming apparatus 10, it is determined at this point whether other user is using (a print function from a remote, of) the image forming apparatus 10, and if not, a dialogue to confirm execution as to shifting to a sleep mode is displayed on the display portion of the operation panel apparatus 22.

When the user instructs the execution of shifting to a sleep mode, a point P4 is added to the accumulated value stored in the point integration table of the user, shifting to a sleep mode is performed, and the user ID and the accumulated value of eco-points stored in the point integration table are transmitted to the point management server 40.

In the case of not restoring to a sleep mode, the authentication start screen is displayed on the display portion of the operation panel apparatus 22, and the user ID and the accumulated value of eco-points stored in the point integration table of the user are transmitted to the point management server 40.

In the point management server 40, user information storage portion may be updated by replacing the accumulated value of eco-points corresponding to the user ID received from the image forming apparatus 10 with the received accumulated value of eco-points.

In the above embodiment, eco-points are accumulated by the image forming apparatus and the accumulated value of the eco-points are held by the point management server, however, an addition point or a deduction point may be transmitted to the point management server to update the accumulated value of eco-points when that point is generated.

Furthermore, in the above embodiment, authentication of a user and the accumulated value of eco-points are managed in the point management server, however, authentication and accumulation of eco-points may be performed only in the image forming apparatus by storing the user information storage portion in the image forming apparatus and using the user information storage portion.

In this case, in authentication accompanied by restoration from a sleep mode, when the point of the user is not more than a predetermined threshold, operation of the apparatus may be prohibited by rejecting authentication.

In the above embodiment, depending on an apparatus attribute of the image forming apparatus, a value of eco-points to be deducted may be adjusted.

For example, when the image forming apparatus is composed of or uses apparatus parts or expendable supplies (for example, power consumption, a toner, paper, etc.) which are made of or from materials for reducing effects on environment, the apparatus attribute corresponding to the amount of reducing effects on environment is stored in a determined storage apparatus.

Then, when the user uses the image forming apparatus, eco-points are more greatly deducted for the lower apparatus attribute stored in the predetermined storage apparatus than for the higher one.

It is thereby possible to urge users to use an image forming apparatus which uses more materials that reduce effects on environment.

When an embodiment is configured above, it is possible to promote improving users' senses of consideration for environment since a point value more appropriately corresponding to a degree of effects on environment is calculated and displayed.

In addition, it is needless to say that the present invention is not limited to the above-described embodiments, and various changes and modifications are possible within a scope not departing from the summary of the present invention.

According to the present invention, it is possible to promote improving users' senses of environment since a point value more appropriately corresponding to a degree of effects on environment is calculated and displayed.

1. An image forming system, comprising:
an image forming apparatus for giving a deduction point depending on use of resources such as paper or toner when used by a user and an addition point that is given to an energy-saving operation for the apparatus by the user; and
a point management server for performing authentication processing of a user requested from the image forming apparatus and also accumulating deduction points and addition points calculated by the image forming apparatus and managing for each user, wherein
an addition point calculated depending on the lapse of time passed since a user used the image forming apparatus last time and a point giving rate per unit time assigned to the user is added to the point, the point is managed for each user, and the point of a predetermined period is reported to each user.

2. An image forming system, wherein
when the point management server receives a request of authentication processing of a user from the image forming apparatus, the addition point is calculated, depending on the lapse of time since the user used the image forming apparatus last time and a point giving rate per unit time assigned to the user.

3. The image forming system as defined in claim 1, wherein
a deduction point calculated depending on a used amount and a paper size of paper consumed for printing is deducted from the point.

4. The image forming system as defined in claim 1, wherein
a deduction point calculated depending on a consumed amount of toner is deducted from the point.

5. The image forming system as defined in claim 1, wherein
a predetermined deduction point is deducted from the point when a fixing roller of the image forming apparatus is heated to a temperature required for printing.

6. The image forming system as defined in claim 1, wherein
the image forming apparatus has a function of performing user authentication in a sleep mode, and when the user authentication is accompanied by restoration from the sleep mode, a predetermined deduction point is deducted from the point.

7. The image forming system as defined in claim 1, wherein
in a case where moving to a sleep mode is accompanied when use of the image forming apparatus is ended, a predetermined addition point is added to the point.

8. The image forming system as defined in any one of claims 1 to 7, wherein
the image forming apparatus, when the point of a user has become not more than a predetermined threshold, makes the user incapable of operating a function of performing point deduction of the point.

9. The image forming system as defined in any one of claims 1 to 7, wherein
a value of the predetermined deduction point may be adjusted depending on an apparatus attribute of the image forming apparatus.

10. The image forming apparatus for performing authentication processing of a user and also accumulating a deduction point depending on a used amount when a user uses resources such as paper or toner and an addition point that is given when the user performs an energy-saving operation of the apparatus and managing the accumulated points for each user, wherein
an addition point calculated depending on lapse of time passed since the user used the image forming apparatus last time and a point giving rate per unit time assigned to the user is added to the point, and the point is managed for each user, and the point of the predetermined period is reported to each user.

11. The image forming apparatus as defined in claim 10, wherein
in the case of authentication accompanied by restoration from the sleep mode, when the point of the user is a predetermined threshold or less, operation of the apparatus may be prohibited by rejecting authentication.
